(19) United States
(12) Patent Application Publication
(10) Pub. No.: US 2008/0178170 A1
(43) Pub. Date: Jul. 24, 2008

(54) ELECTRONIC APPARATUS, PRINTER, PROGRAM, AND CONSUMABLE

(75) Inventors: Hitoshi Abe, Tokyo (JP); Masanobu Hida, Miyagi (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/744,307

(22) Filed: May 4, 2007

(30) Foreign Application Priority Data
May 12, 2006 (JP) 2006-133414

(51) Int. Cl. G06F 9/44

(52) U.S. Cl. 717/170

(57) ABSTRACT

An electronic apparatus includes: a consumable-version-information holding section that holds version information of firmware read from an information medium of a consumable loaded in an own machine; an own-machine-version information holding section that holds version information of firmware currently used in the own machine; a version information comparing section that compares version information of the consumable and version information of the own machine with each other; and an update message notifying section that displays a message that prompts updating of firmware on an information display section of the own machine or another machine when the version information of the consumable is newer than the version information of the own machine.

### CROSS REFERENCES TO RELATED APPLICATIONS

The present invention contains subject matter related to Japanese Patent Application JP 2006-133414 filed in the Japanese Patent Office on May 12, 2006, the entire contents of which are incorporated herein by reference.

### BACKGROUND OF THE INVENTION

1. Field of the Invention

The invention disclosed in this specification relates to a technique for prompting the user to update firmware when automatic firmware updating may not be possible. It should be noted that firmware refers to basic software embedded in an electronic apparatus for controlling hardware.

The scope of the invention proposed by the present inventors encompasses an electronic apparatus, a printer, a program, and a consumable.

2. Description of the Related Art

Firmware embedded in an electronic apparatus needs to be updated at appropriate times in order to provide functionality enhancements or fix problems. Normally, a firmware update is announced via a WEB site set up on the internet.

However, this announcement is one-sided. Therefore, unless the user himself/herself voluntarily accesses this kind of announcement, the user may not be able to learn about and actually perform such a firmware update.

In view of this, a technique for automatically updating firmware via a computer network has been proposed.

However, all electronic apparatuses may not always be connected to a computer network. In practice, some electronic apparatuses may be used in locations where computer network connectivity is not available.

In view of this, Japanese Unexamined Patent Application Publication No. 2005-215599 discloses a system in which updated firmware is stored in a non-volatile memory of an ink cartridge or the like that is a consumable, and the updated firmware is automatically downloaded upon replacing the consumable to thereby update firmware.

However, the application of this method is limited to cases where the file size of updated firmware is less than the storage capacity of the non-volatile memory. That is, this method is subject to the constraint of the capacity of the non-volatile memory that can be incorporated into the consumable.

Further, according to this method, the firmware version to which firmware can be updated is limited to the firmware version stored in the non-volatile memory. That is, even when new firmware is provided after the consumable is placed into commercial distribution, it may be impossible to update the firmware of the electronic apparatus to a version newer than the firmware version stored in the consumable.

### SUMMARY OF THE INVENTION

In view of this, the present inventors propose a system with the following processing functions incorporated into an electronic apparatus that operates with a replaceable consumable loaded therein.

(a) A consumable-version-information holding section that holds version information of firmware read from an information medium of a consumable loaded in an own machine.
(b) An own-machine-version information holding section that holds version information of firmware currently used in the own machine.
(c) A version information comparing section that compares version information of the consumable and version information of the own machine with each other.
(d) An update message notifying section that displays a message that prompts updating of firmware on an information display section of the own machine or another machine when the version information of the consumable is newer than the version information of the own machine.

When the system proposed by the present inventors is adopted, the user can be notified of the necessity for updating firmware through the replacing operation of a consumable even under usage environments where it may be impossible to execute automatic firmware updating via a computer network.

Further, according to the system proposed by the present inventors, updated firmware is not stored in the information medium of a consumable. Therefore, it is possible to broaden the kind of storage medium to which this system can be adapted. In addition, there is no constraint placed on the file size of updated firmware.

Further, when updating firmware, the firmware can be updated to the latest firmware at all times.

### BRIEF DESCRIPTION OF THE DRAWINGS

FIG. 1 is a view shown an example of the exterior configuration of a self-operation type printer;

FIG. 2 is a diagram showing an example of the structure of data stored in an IC tag;

FIG. 3 is a diagram showing an example of the internal configuration of a self-operation type printer;

FIG. 4 is a diagram showing an example of the functional configuration for realizing a firmware update management function;

FIG. 5 is a diagram showing an example of processing at the time of replacing an ink ribbon;

FIG. 6 is a view showing an example of the screen that prompts checking of firmware;

FIG. 7 is a view showing an example of the massage that prompts updating of firmware;

FIG. 8 is a view showing an example of the message relating to the locations for acquiring updated firmware;

FIG. 9 is a diagram illustrating an example of the update operation in the case where a self-operation type printer is used in a standalone mode;

FIG. 10 is a diagram illustrating an example of the update operation in the case where a self-operation type printer is used in a standalone mode;

FIG. 11 is a diagram illustrating an example of the update operation in the case where a self-operation type printer is used in a standalone mode;

FIG. 12 is a diagram illustrating an example of the update operation in the case where a self-operation type printer is directly connected to a computer network;

FIG. 13 is a diagram illustrating an example of the update operation in the case where a self-operation type printer is indirectly connected to a computer network;

FIG. 14 is a view showing an example of the exterior appearance of a printer;

FIG. 15 is a view showing an example of how an information medium is incorporated in an ink cartridge;

FIG. 16 is a view showing an example of the exterior appearance of a multifunction machine;

FIG. 17 is a view showing an example of the exterior appearance of a fax machine;

FIG. 18 is a view showing an example of how an information medium is incorporated in a toner cartridge;

FIG. 19 is a view showing an example of the exterior appearance of a label printing machine;

FIG. 20 is a view showing an example of how an information medium is incorporated in a tape cartridge;

FIG. 21 is a view showing another example of how an information medium is incorporated in a consumable; and

FIG. 22 is a diagram showing another example of the data structure of an information medium adhered to a consumable.

### DESCRIPTION OF THE PREFERRED EMBODIMENTS

A firmware-update prompting technique according to an embodiment of the present invention will now be described below.

It should be noted that techniques that are well known or publicly known in the technical field to which the present invention belongs shall be applied to the features not specifically illustrated or described in this specification.

Further, it is to be understood that the embodiment described below illustrates one example of the embodiment of the present invention, and the present invention is not limited to this.

### (A) Self-Operation Type Printer

Description will now be given of a case where the technique proposed by the present inventors is incorporated into a self-operation type printer. It should be noted that in this specification, the self-operation type printer refers to a printing system for commercial use installed in stores, event sites, and other such locations.

In the following description, it is assumed that the self-operation type printer is connected to a computer network. That is, it is assumed that the self-operation type printer is used in a standalone mode.

### (A-1) Example of Exterior Configuration

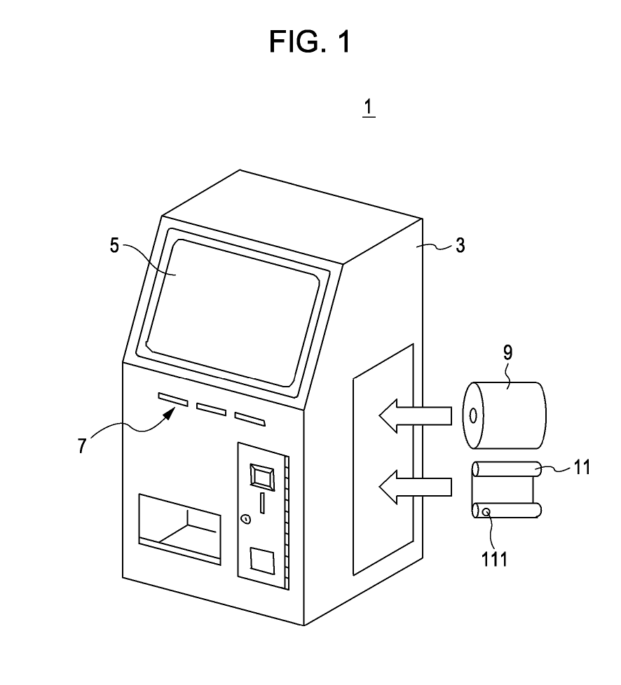

FIG. 1 shows an example of the exterior configuration of a self-operation type printer 1. The self-operation type printer 1 has a controller and a sublimation type printer that are built in a box-shaped casing 3.

A touch panel screen 5 is arranged in an upper portion of the front surface of the casing 3. The touch panel screen 5 is a composite type display device with a touch screen arranged on the front surface of its display screen.

A medium insertion port 7 allowing insertion of an external storage medium brought by the user is arranged at the central portion of the front surface of the casing 3. A plurality of kinds of the medium insertion port 7 are provided in accordance with the shape or specifications of a portable storage medium. For example, a disc-shaped optical storage medium, or a card-shaped or chewing-gum-shaped semiconductor storage device is used as such a portable storage medium.

Money deposit and return slots for payment adjustment and a photograph delivery slot are arranged in a lower portion of the front surface of the casing 3. A printed photograph is discharged from the photograph delivery slot. The user can take out a printed photograph by inserting a hand into the photograph delivery slot.

It should be noted that roll paper (a printing medium wound into a roll) 9 and an ink ribbon 11 are loaded in the self-operation printer 1 as consumables. The ink ribbon 11 includes a feed spool having wound thereon a film coated with solid ink corresponding to basic print colors, and a take-up spool for taking up the film in accordance with printing, and an accommodating case accommodating these components.

In this embodiment, four colors of yellow (Y), magenta (M), cyan (C), and black (K) are used as the basic print colors.

An IC tag 111 storing information relating to firmware update notification is adhered onto the accommodating case for the ink ribbon 11. Communication with the IC tag 111 may be done in either a contact or non-contact manner.

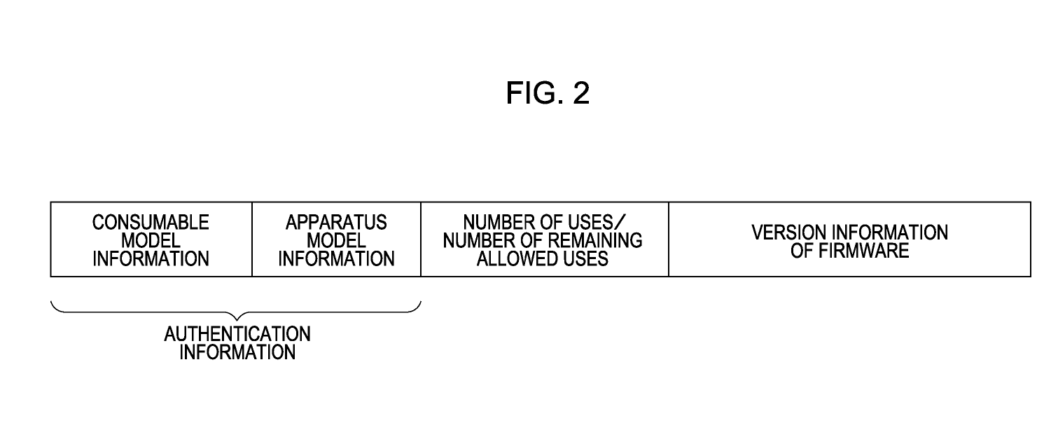

FIG. 2 shows a part of the structure of data stored in the IC tag 111.

In the case shown in FIG. 2, ink ribbon authentication information, the number of uses of and the number of remaining allowed uses of an ink ribbon, and firmware version information are stored.

Of these pieces of information, as the ink ribbon authentication information, information (consumable model identification information) for identifying the model of an ink ribbon, and information (apparatus model information) relating to the model of an apparatus for which the consumable can be used.

### (A-2) Configuration Inside Casing

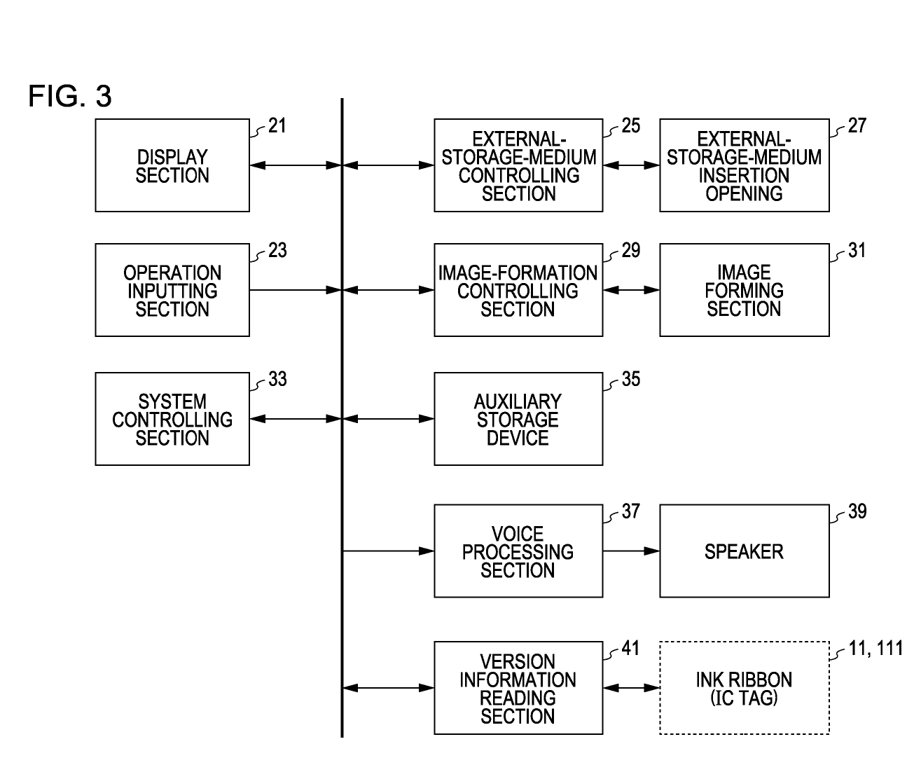

FIG. 3 shows the functional block configuration inside the self-operation type printer 1. The self-operation type printer 1 includes a display section 21, an operation inputting section 23, an external-storage-medium controlling section 25, an external-storage-medium insertion port 27, an image-formation controlling section 29, an image forming section 31, a system control section 33, an auxiliary storage device 35, a voice processing section 37, a speaker 39, and a version information reading section 41.

The display section 21 is a display device that displays a photoprint reception screen or other such information. For example, the display section 21 is formed by a CRT display or a flat panel display. At the time of photoprinting, for example, a screen for receiving a selection of the printing image, the output number of prints, the output size, and the like is displayed.

The operation inputting section 23 is an input device for giving the system control section 33 an instruction corresponding to an operation of the user. As described above, a touch panel is used as the operation inputting section 23 in this embodiment. However, the operation inputting section 23 may be formed by a button, a switch, or other such pointing device as well.

The external-storage-medium controlling section 25 is a control device for controlling the reading and writing of data with respect to an external storage medium inserted into the external-storage-medium insertion port 27 (the insertion port 7 shown in FIG. 1). The external-storage-medium controlling section 25 realizes a function of making access to the file system of an external storage medium to read a necessary data file. The read image file is stored into the auxiliary storage device 35. Further, the external-storage-medium controlling section 25 also realizes a function of writing information relating to the input destination of updated firmware into an external storage device.

The image-formation controlling section 29 is a control device for controlling the output of image data to the image forming section 31 connected via a connector. Normally, a plurality of the image forming sections 31 are incorporated for different print sizes. Accordingly, the image-formation controlling section 29 provides a function of outputting image data corresponding to a print cue corresponding to the size designated by the user. It should be noted that examples of the print size include an L size, KG size, 2L size, and panorama size. In this embodiment, a sublimation print head is used for the image forming section 31.

The system control section 33 is a control device for controlling the entire system in accordance with firmware. The system control section 33 is formed by, for example, a microcomputer. The system control section 33 provides not only a control function relating to the execution of printing but also a control function relating to the firmware version management. The functional block configuration of the system control section 33 corresponding to the control function relating to the firmware version management will be described later.

The auxiliary storage device 35 is a storage device used for storing firmware, image data, advertisement data, and the like. The auxiliary storage device 35 is formed by, for example, a hard disk device as an example of a magnetic storage device.

The voice processing section 37 is a signal processing device for voice output of operation explanation or advertisement. Voice or musical sound is outputted through the speaker 39.

The version information reading section 41 is a processing device that reads, upon detecting the loading of a new ink ribbon 11, the version information of firmware corresponding to the ink ribbon 11 through communication with the IC tag 111 adhered onto the ink ribbon 11. The version information read through communication with the IC tag 111 is given to the system control section 33.

### (A-3) Firmware Update Management Function

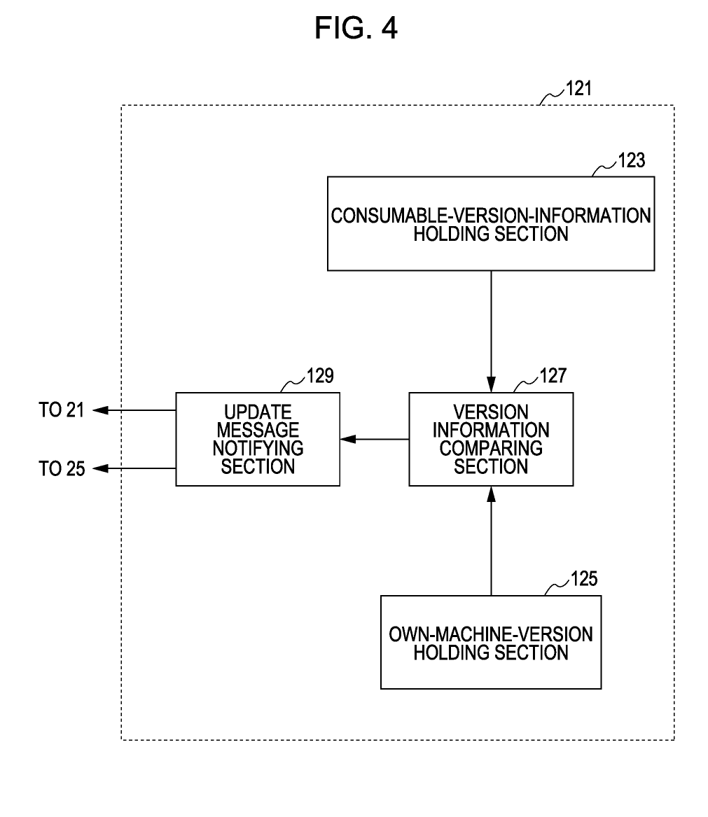

FIG. 4 shows an example of the functional configuration for realizing a firmware update management function 121. The firmware update management function 121 is realized through the system control section 33 as a part of the functions incorporated in firmware.

The firmware update management function 121 includes a consumable version information holding section 123, an own-machine-version information holding section 125, a version information comparing section 127, and an update message notifying section 129.

The consumable version information holding section 123 is a storage area for holding the version information of firmware corresponding to the ink ribbon 11 being loaded.

The own-machine-version information holding section 125 is a storage area for holding information on the current version of the firmware embedded in the self-operation type printer 1.

The version information comparing section 127 realizes a function of comparing the version information of an ink ribbon and the version information of an own machine with each other.

The update message notifying section 129 realizes a function of causing a message that prompts updating of firmware to be displayed on the display section 21 (touch panel screen 5) in the case where the version information of the ink ribbon 11 is newer than the version information of the own machine.

It should be noted that when direct communication with peripheral apparatus or communication with another apparatus via a computer network is possible, the update message notifying section 129 displays a message prompting updating of firmware on the screen of a display device mounted in such an apparatus.

(A-4) Example of Processing during Ink Ribbon Replacement

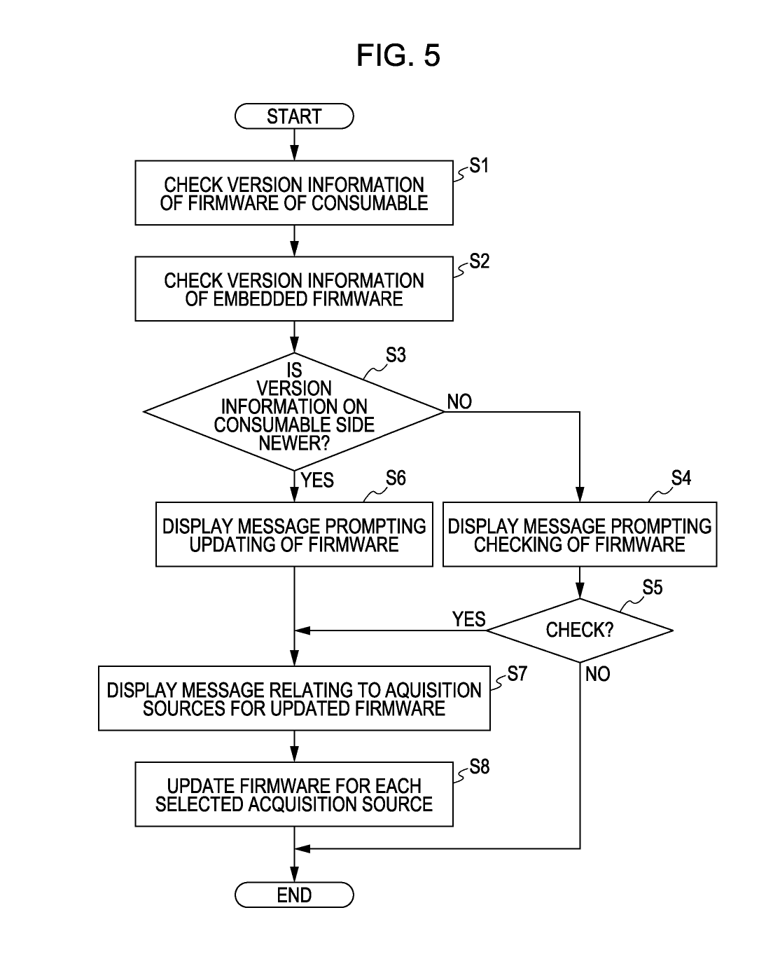

An example of the processing executed during replacement of the ink ribbon 11 will now be described with reference to FIG. 5.

The processing shown in FIG. 5 is realized through the firmware update management function 121 of the system control section 33.

First, the user (including the service staff) opens a maintenance panel, and replaces the used ink ribbon 11 with a new ink ribbon 11.

The loading of the new ink ribbon 11 into the apparatus body is detected by a sensor or the like arranged in the vicinity of the loading location. Upon this detection, the system control section 33 checks the firmware version information corresponding to the IC tag 111 (S1).

Next, the system control section 33 checks the version information of the firmware embedded in the own machine (S2).

Thereafter, the system control section 22 compares the two pieces of version information with each other, and determines whether or not the version information on the ink ribbon 11 side is newer (S3).

If the result of the determination processing S3 is negative, the system control section 33 displays a screen (S4) prompting the checking of firmware (S4).

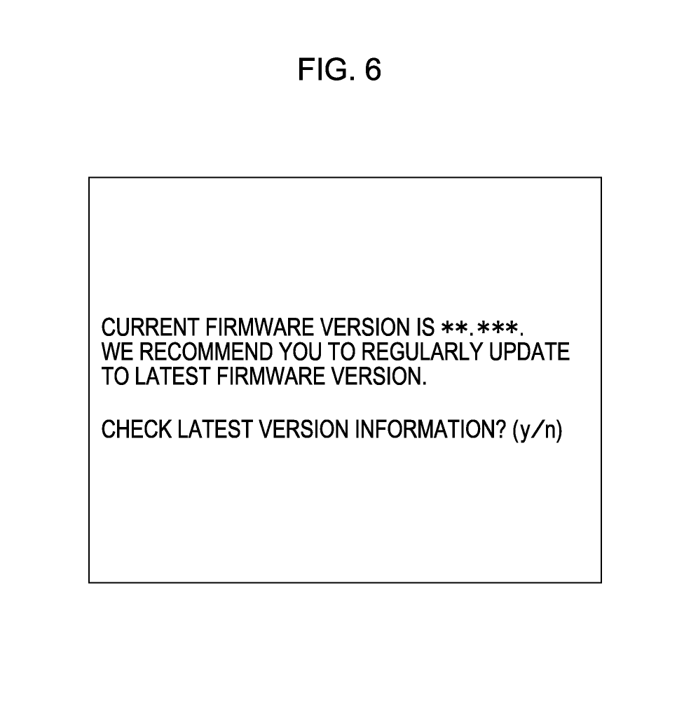

FIG. 6 shows an example of a message screen prompting the checking of firmware. As shown in FIG. 6, a message prompting the user to check the current version information of embedded firmware and the latest version information.

At this point, the system control section 33 determines whether or not the checking of the latest version information has been selected (S5).

If the result of the determination processing S5 is negative, the system control section 33 ends the firmware update management function that has started with the replacement of the ink ribbon 11 as a trigger.

On the other hand, if the result of the determination processing S6 is positive, the system control section 33 transfers to the processing S7 that will be described later.

Incidentally, if the result of the determination processing S3 has been positive, that is, if the version information of the ink ribbon 11 is newer than the version information of the own machine, the system control section 33 displays a massage prompting updating of firmware on the screen of the display section 21 (S6).

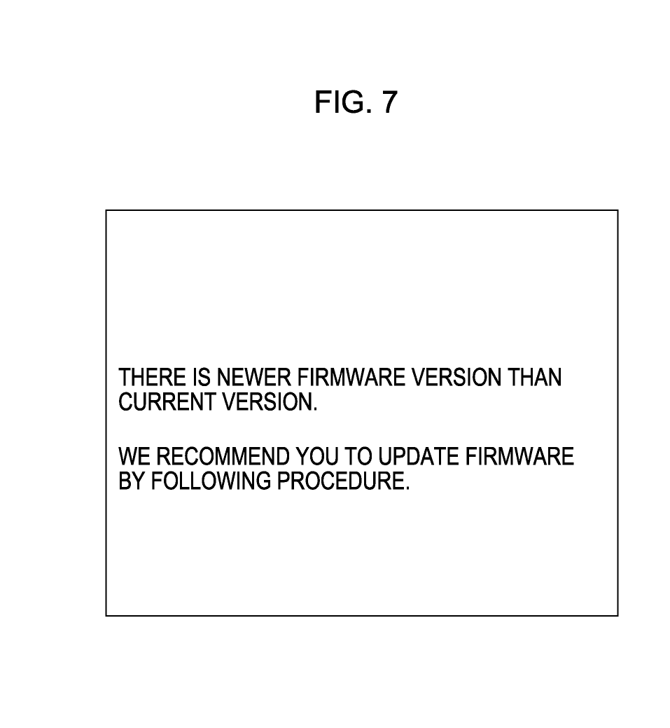

FIG. 7 shows an example of a message prompting a firmware update.

In the case shown in FIG. 7, the message also suggests the specific procedure for a firmware update.

In this embodiment, the system control section 33 displays on the screen of the display section 21 a message relating to the acquisition sources for acquiring updated firmware (S7).

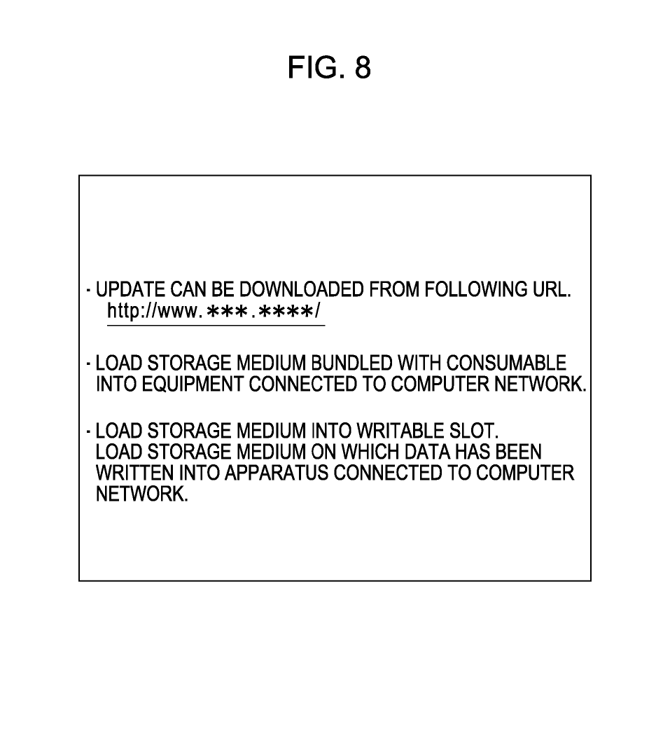

FIG. 8 shows an example of a display message relating to the acquisition sources for updated firmware.

In the case shown in FIG. 8, three kinds of acquisition source are presented. For example, as one of the acquisition sources, a link (URL: Uniform Resource Locator) for firmware updates is presented. This acquisition source can be selected in cases where the latest firmware can be downloaded via a computer network.

Further, for example, as one of the acquisition sources, loading (placement) of a storage medium (a CD-ROM, a magnetic disc, a semiconductor storage device, an optical disc, or the like) bundled with the ink ribbon 11 into the apparatus body is presented. This display can be selected in cases where a link indicating the acquisition sources for firmware or an execution program for connection to the acquisition sources for firmware is stored in the storage medium.

Further, for example, as one of the acquisition sources, loading (placement) of a storage medium into a slot to which data can be written is presented. This display can be selected in cases where a link indicating the acquisition sources for firmware or an execution program for connection to the acquisition sources for firmware is stored within the self-operation type printer 1 or in an IC tag or the like.

Thereafter, the system control section 33 acquires the latest firmware from each individual acquisition source selected by the user, thereby updating embedded firmware (S8).

### (A-5) Update Operation for Firmware

### (1) Update Operation 1

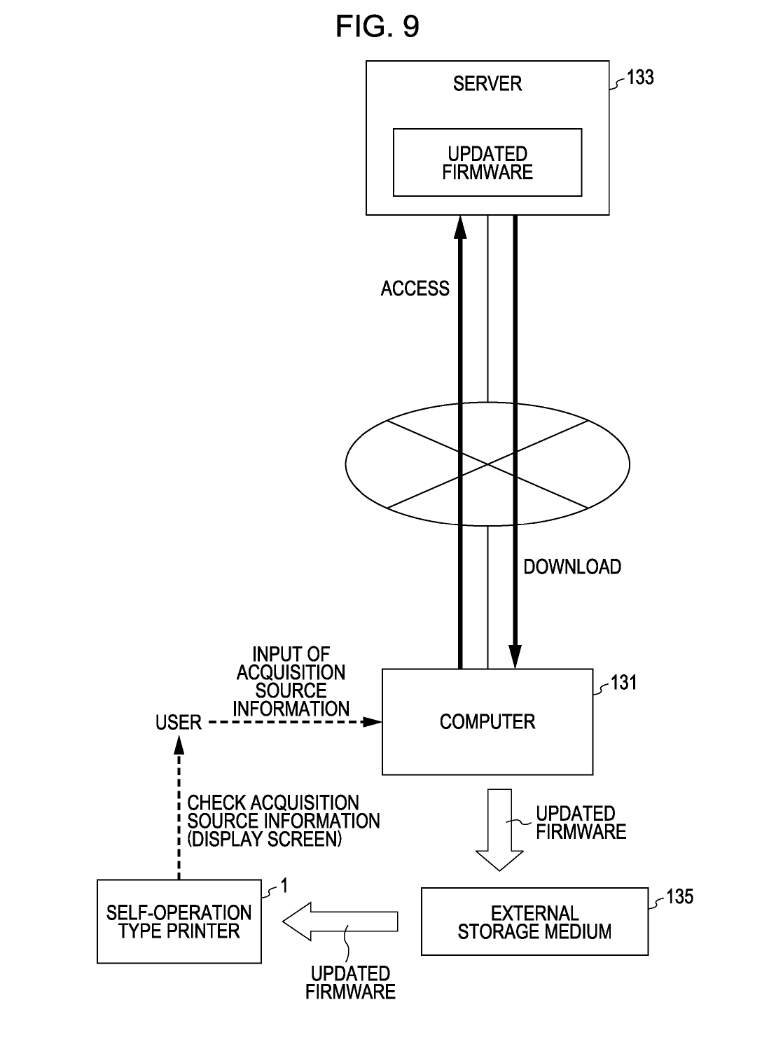

For example, when the self-operation type printer 1 is used in a standalone mode, updating to the latest updated firmware is performed in accordance with the procedure shown in FIG. 9.

In this case, first, the user inputs the URL of a link to a computer 131 connected to a computer network. In accordance with the inputted URL, the computer 131 makes access to a server 133 in which the latest updated firmware is stored. The updated firmware is downloaded to the computer 131 through communication with the server 133.

The downloaded updated firmware is transferred to an external storage medium 135. A semiconductor storage medium, an optical disc, a magnetic disc, or the like is used as the external storage medium 135. Thereafter, the external storage medium 135 is loaded into the self-operation type printer 1, and the downloaded firmware is transferred to the self-operation type printer 1, thereby completing updating of embedded firmware.

It should be noted that in the case where the computer 131 and the self-operation type printer 1 are connected to each other through a connection cable such as an USB or a wireless transmission path such as radio waves or infrared rays, the downloaded firmware is directly transferred from the computer 131 to the self-operation type printer 1 without using the external storage medium 135.

### (b) Update Operation 2

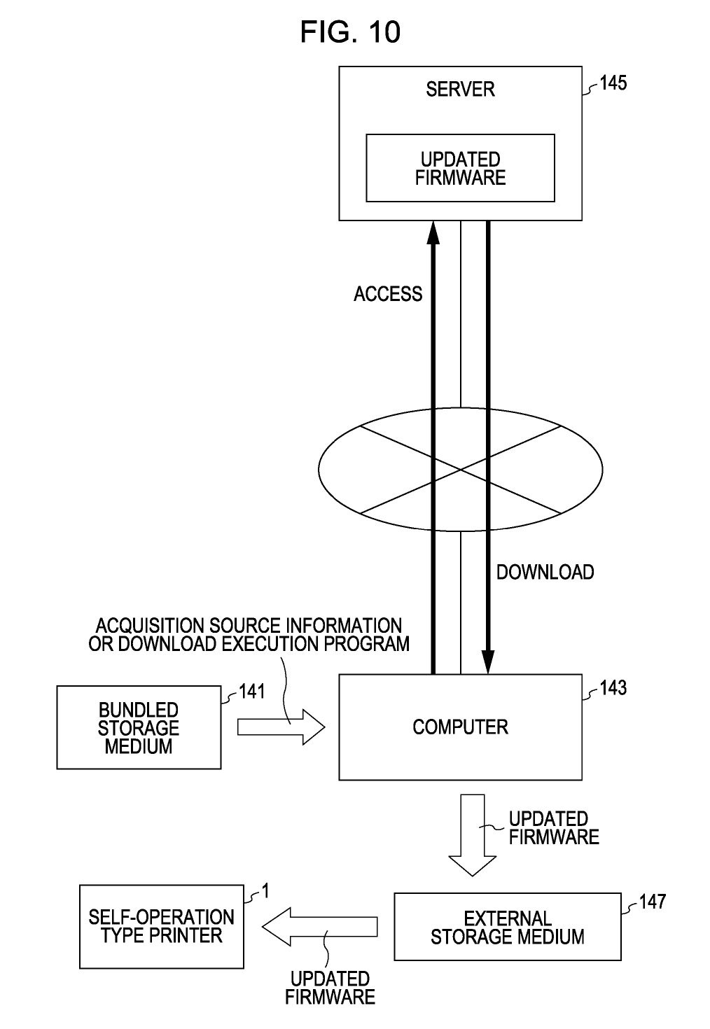

Another method may be employed for the update operation in the case where the self-operation type printer 1 is used in a standalone mode. For example, updating to the latest updated firmware can be performed in accordance with the procedure shown in FIG. 10.

In this case, the user loads a storage medium 141, which is bundled with the ink ribbon 11, into a computer 143 connected to a computer network.

The computer 143 reads from the storage medium 141 the URL of a link for firmware updates or an execution program for connection to the acquisition sources for firmware, and in accordance with this information or program, the computer 143 makes access to a server 145 in which the latest updated firmware is stored. The updated firmware is downloaded to the computer 143 through communication with the server 145.

The downloaded updated firmware is transferred to an external storage medium 147. A semiconductor storage medium, an optical disc, a magnetic disc, or the like is used as the external storage medium 147. Thereafter, the external storage medium 147 is loaded into the self-operation type printer 1, and the downloaded firmware is transferred to the self-operation type printer 1, thereby completing updating of embedded firmware.

It should be noted that in the case where the computer 143 and the self-operation type printer 1 are connected to each other through a connection cable such as an USB or a wireless transmission path such as radio waves or infrared rays, the downloaded firmware is directly transferred from the computer 143 to the self-operation type printer 1 without using the external storage medium 147.

### (c) Update Operation 3

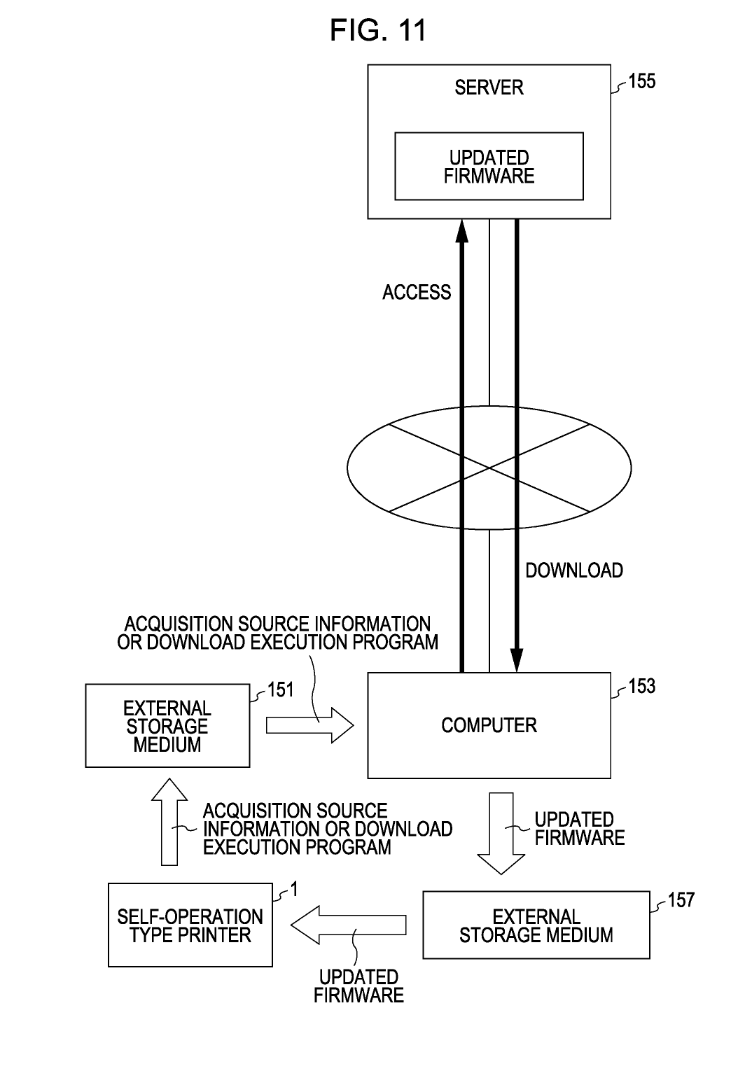

Still another method may be employed for the update operation in the case where the self-operation type printer 1 is used in a standalone mode. For example, updating to the latest updated firmware can be performed in accordance with the procedure shown in FIG. 11.

First, the user loads a writable external storage medium 151 into the self-operation type printer 1.

In this case, the URL of a link for firmware updates or an execution program for connection to the acquisition sources for firmware is transferred to the loaded external storage medium 151 from the self-operation type printer 1.

Thereafter, the external storage medium 151 is loaded into a computer 153 connected to a computer network.

The computer 153 reads from the storage medium 151 the URL of a link for firmware updates or an execution program for connection to the acquisition sources for firmware, and in accordance with this information or program, the computer 153 makes access to a server 155 in which the latest updated firmware is stored. The updated firmware is downloaded to the computer 153 through communication with the server 155.

The downloaded updated firmware is transferred to an external storage medium 157. A semiconductor storage medium, an optical disc, a magnetic disc, or the like is used as the external storage medium 157. The external storage medium 157 may be the same as the external storage medium 151 used for the writing of a link URL or the like.

Thereafter, the external storage medium 157 is loaded into the self-operation type printer 1, and the downloaded firmware is transferred to the self-operation type printer 1, thereby completing updating of embedded firmware.

It should be noted that in the case where the computer 153 and the self-operation type printer 1 are connected to each other through a connection cable such as an USB or a wireless transmission path such as radio waves or infrared rays, the downloaded firmware is directly transferred from the computer 153 to the self-operation type printer 1 without using the external storage medium 157.

### (d) Update Operation 4

Here, description will be given of the update operation in the case where the self-operation type printer 1 is connected to a computer network.

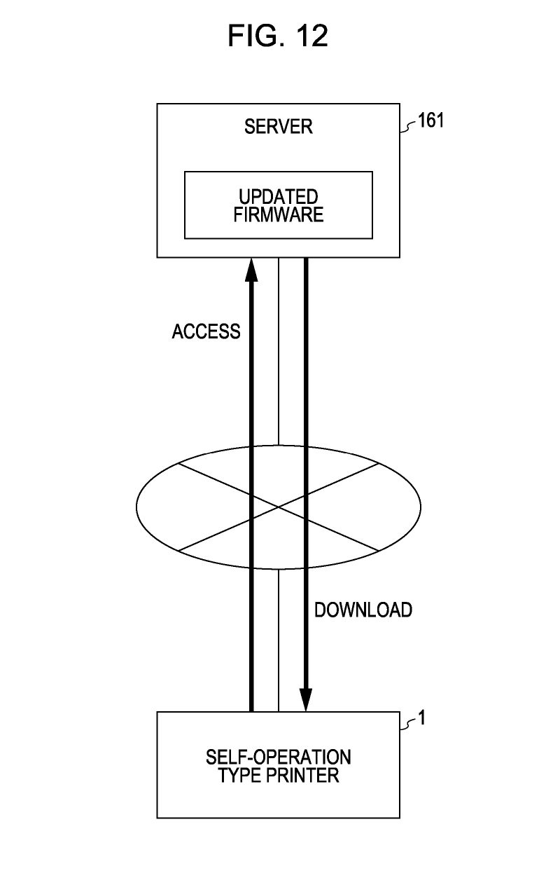

First, as shown in FIG. 12, description will be given with respect to a case where the self-operation type printer 1 is directly connected to a computer network.

Here, the expression “is directly connected” means that the self-operation type printer 1 is connected to a computer network through a network terminal (for example, Ethernet (registered trademark) terminal) of the self-operation type printer 1.

In this case, when the user designates download of updated firmware from a link URL displayed on the display screen, the self-operation type printer 1 directly accesses the link URL read from the IC tag 111.

As a result, the self-operation type printer 1 downloads the updated firmware through communication with a server 161.

Thereafter, the self-operation type printer 1 automatically updates the embedded firmware with the downloaded firmware. This completes the embedding operation.

### (e) Update Operation 5

Subsequently, description will be given of the update operation in the case where the self-operation type printer 1 is connected to a computer network.

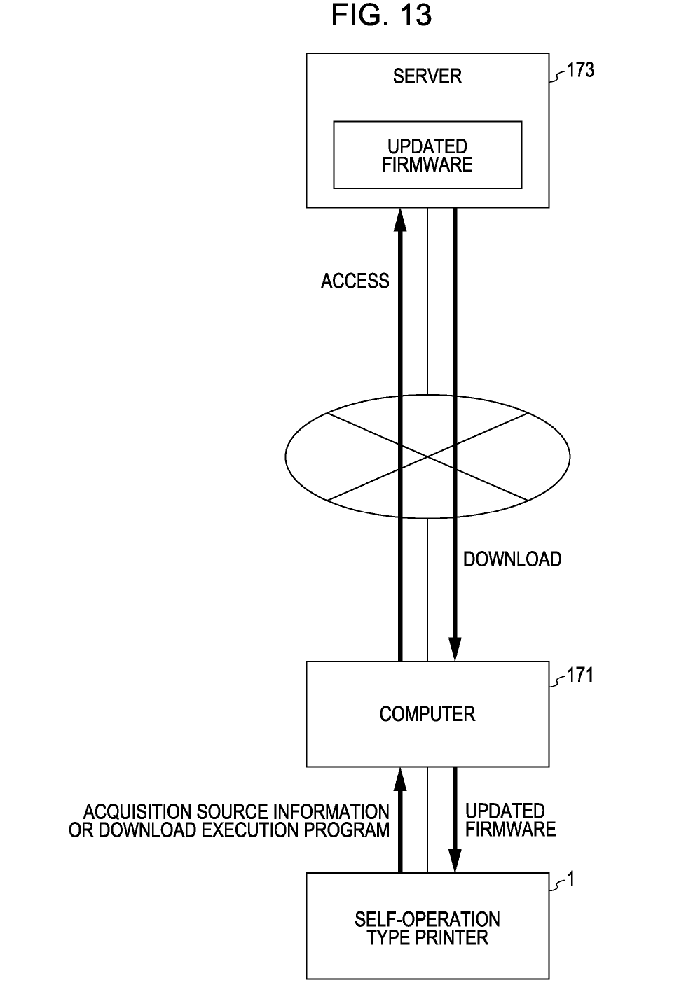

Here, as shown in FIG. 13, description will be given with respect to a case where the self-operation type printer 1 is indirectly connected to a computer network.

Here, the expression “is indirectly connected” means that a computer 171, to which the self-operation type printer 1 is connected, is connected to a computer network through its network terminal (for example, Ethernet (registered trademark) terminal).

In this case, when the user designates download of updated firmware from a link URL displayed on the display screen, a link indicating the acquisition sources for firmware or an execution program for connection to the acquisition sources for firmware is transferred to the computer 171.

In accordance with the inputted URL, the computer 171 makes access to a server 173 in which the latest updated firmware is stored. The updated firmware is downloaded to the computer 171 through communication with the server 173.

In this case, since the computer 171 and the self-operation type printer 1 are connected to each other so as to be capable of communication, the downloaded updated firmware is transferred from the computer 171 to the self-operation type printer 1.

Thereafter, the self-operation type printer 1 automatically updates the embedded firmware with the transferred firmware. This completes the embedding operation.

### (A-5) Effect of Embodiment

As described above, when this firmware update management function is incorporated, if the version information of the replaced ink ribbon 11 is newer than the version information of the own machine, a message prompting a firmware update can be displayed on the screen of the display section 21. The incorporation of this function makes it possible to reliably notify the user of the necessity for updating firmware.

The incorporation of this function makes it possible to prompt the updating of firmware embedded in the self-operation type printer 1.

Further, a firmware update according to this embodiment is finally realized through downloading of the latest firmware from a server on a computer network. Therefore, the file size of the firmware is not restricted by the storage capacity of the IC tag as in the case of the related art.

Further, according to this embodiment, the latest firmware can be downloaded from the server of a manufacturer or the like at all times. Therefore, it is also possible to overcome the problem with the related art in which the automatic updating of firmware does not necessarily guarantee that the version of the updated firmware is the latest one.

It should be noted that this embodiment can be adapted to handle a plurality of methods of accessing the server, in accordance with how the self-operation type printer 1 is used.

For example, there is provided a function of displaying acquisition source information for updated firmware on the screen. Alternatively, for example, there is provided a function of outputting the URL or the like of the acquisition source for updated firmware to an external storage medium. Alternatively, for example, there is provided a function of prompting the loading of a storage medium bundled with the ink ribbon 11 into another electronic apparatus that can be connected to a computer network.

Through these functions, the latest firmware can be downloaded from the server of a manufacturer or the like even when the self-operation type printer 1 is used in a standalone mode.

Of course, when the self-operation type printer 1 is directly or indirectly connected to a computer network, the latest firmware can be downloaded from the server of a manufacturer or the like directly or indirectly through another electronic apparatus.

### (B) Examples of Application to Other Systems

In the above-described embodiment, description is directed to the case where the firmware update management function is incorporated into the self-operation type printer 1 installed in stores and the like.

However, the firmware update management function can also be incorporated into other systems.

### (B-1) Application to Other Printers

The firmware update management function proposed by the present inventors can be also incorporated into printers for office or home use and printers used in medical institutions. The basic functional configuration in this case is the same as that of the above-described embodiment.

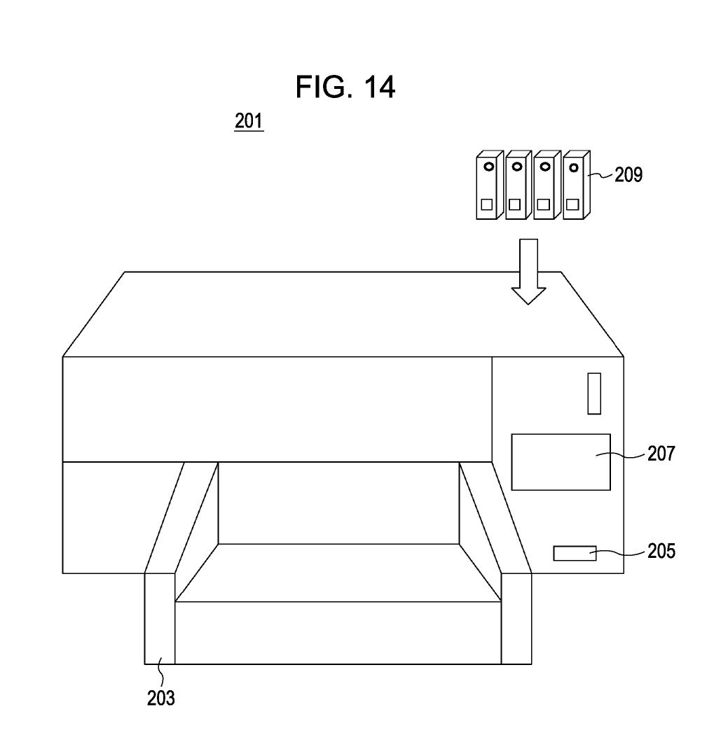

FIG. 14 shows an example of the exterior appearance of a printer 201 of this kind. The printer 201 has a sheet delivery section, a medium insertion port 205, and a display section 207 in the front surface of a casing 203.

Further, the door of the casing can be opened and closed to allow loading of an ink cartridge (included a head-integrated ink cartridge) 209 into the apparatus body.

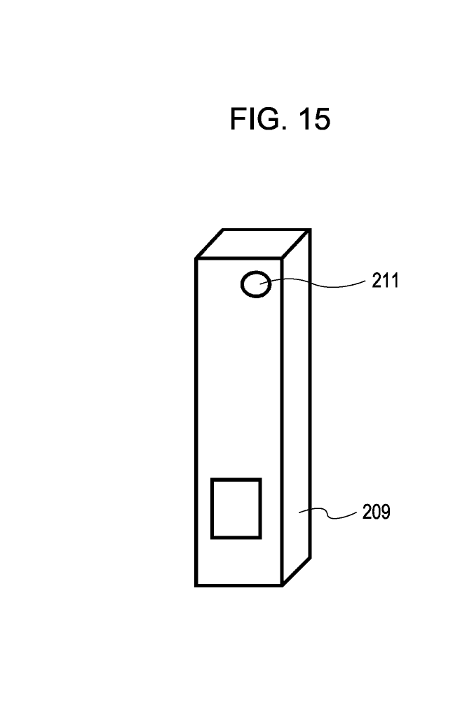

In this embodiment, as shown in FIG. 15, the version information of firmware and information relating to the acquisition sources for updated firmware are stored in an IC tag 211 of the ink cartridge 209.

(B-2) Application to Multifunction Machine with Scanner Incorporated into Printer

The firmware update management function proposed by the present inventors can be also incorporated into a multifunction type printer (multifunction machine) incorporating a scanner. The basic functional configuration in this case is the same as that of the above-described embodiment.

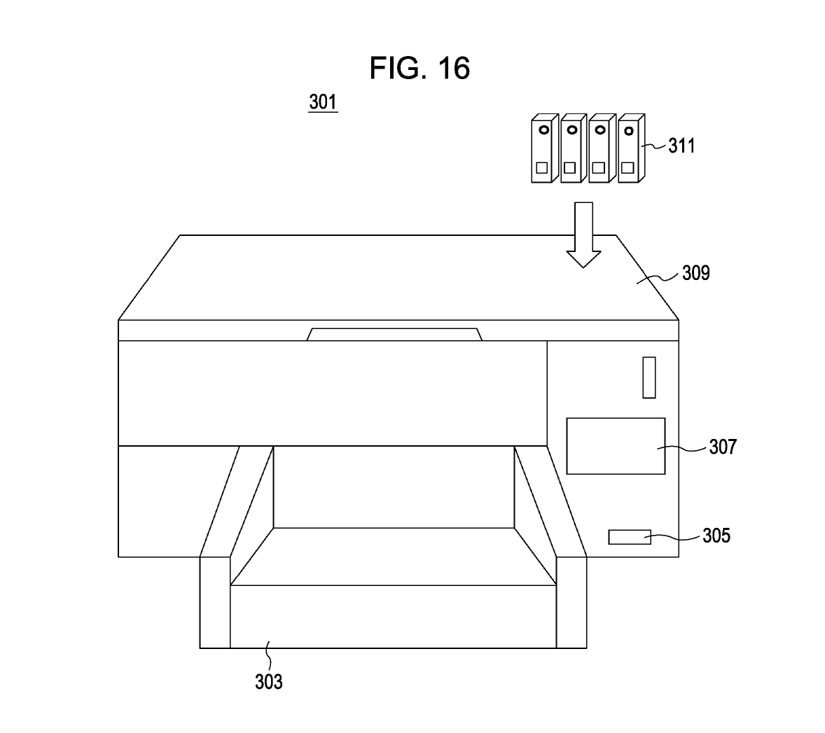

FIG. 16 shows an example of the exterior appearance of a multifunction machine 301. The multifunction machine 301 has a sheet delivery section, a medium insertion port 305, and a display section 307 in the front surface of a casing 303. Further, the multifunction machine 301 incorporates a scanner 309 mounted in the top surface of the casing.

Further, the door of the casing can be opened and closed to allow loading of an ink cartridge (included a head-integrated ink cartridge) 311 into the apparatus body. Of course, the version information of firmware and information relating to the acquisition sources for updated firmware are stored in an IC tag of the ink cartridge 311.

It should be noted that in the case where toner is used for the fixation of an image, the IC tag is adhered to the container of a toner cartridge.

### (B-3) Application to Fax Machine

The firmware update management function proposed by the present inventors can be also incorporated into a fax machine. The basic functional configuration in this case is the same as that of the above-described embodiment.

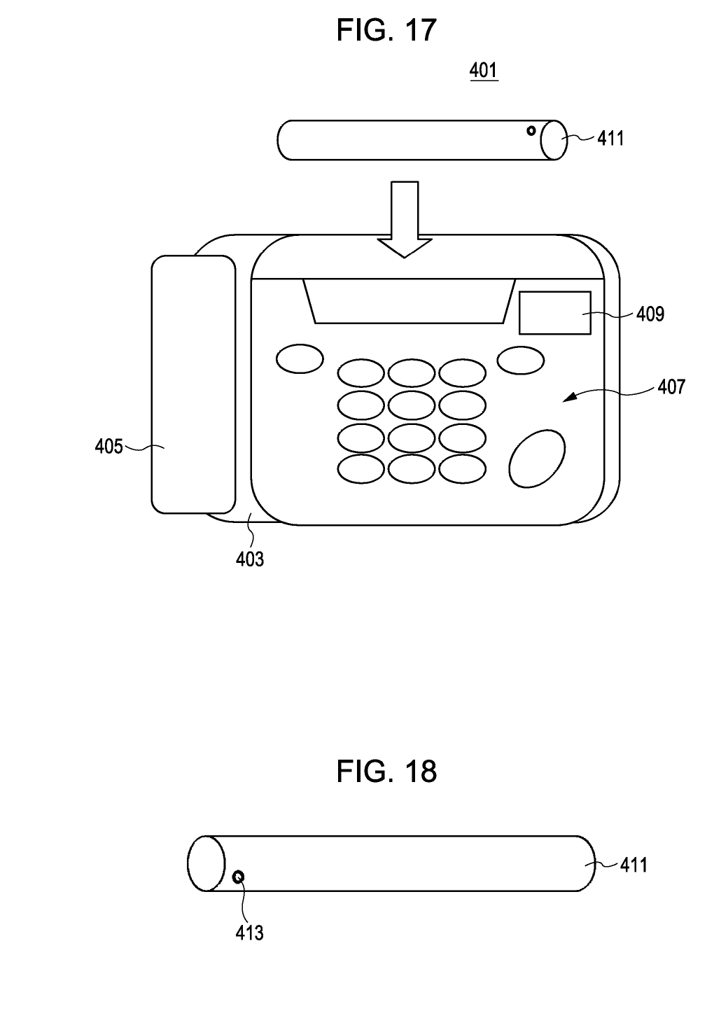

FIG. 17 shows an example of the exterior appearance of a fax machine 401. The fax machine 401 has a handset 405, operation buttons 407, and a display section 409 on the left side of the front surface of a casing 403.

Further, the door of the casing can be opened and closed to allow loading of a toner cartridge 411 into the apparatus body. Of course, as shown in FIG. 18, the version information of firmware and information relating to the acquisition sources for updated firmware are stored in an IC tag 413 of the toner cartridge 411.

### (B-4) Application to Label Printing Machine

The firmware update management function proposed by the present inventors can be also incorporated into a label printing machine. The basic functional configuration in this case is the same as that of the above-described embodiment.

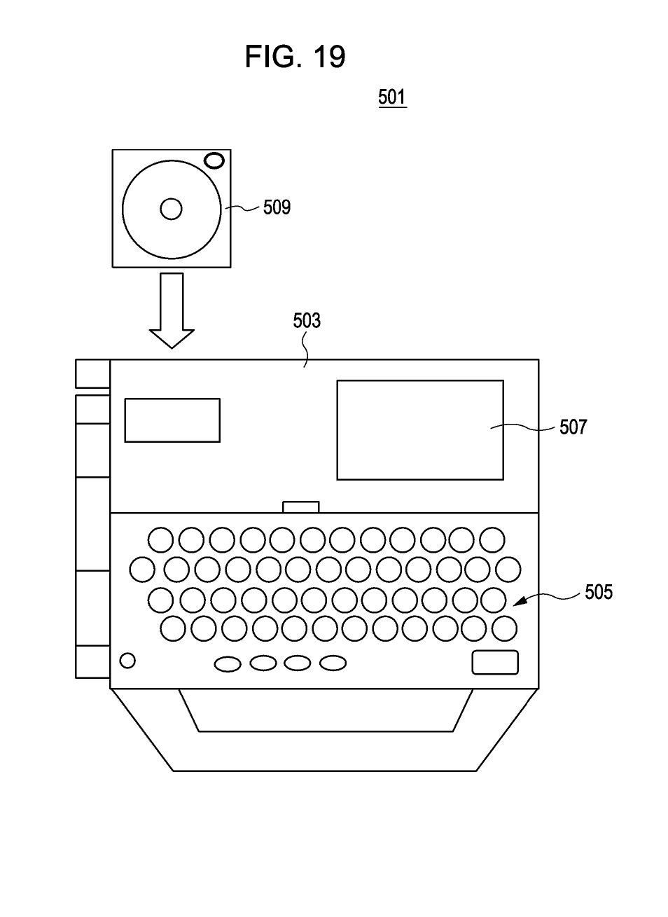

FIG. 19 shows an example of the exterior appearance of a label printing machine 501. The label printing machine 501 has operation buttons 505 and a display section 507 on the front surface of a casing 503.

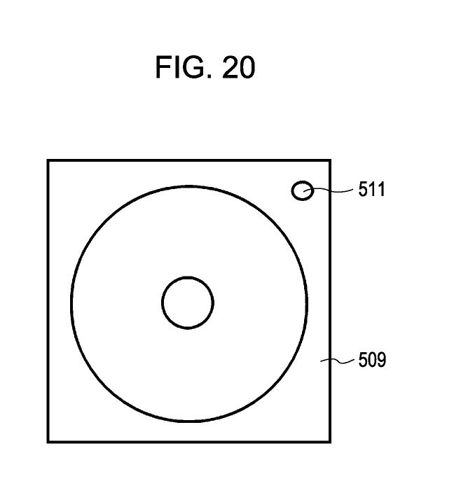

Further, the door of the casing can be opened and closed to allow loading of a tape cartridge 509 into the apparatus body. Of course, as shown in FIG. 20, the version information of firmware and information relating to the acquisition sources for updated firmware are stored in an IC tag 511 of the tape cartridge 509.

### (C) Other Embodiments

(a) In the above-described embodiment, the description is directed to the case where an IC tag is attached to a cartridge accommodating an image-forming material.

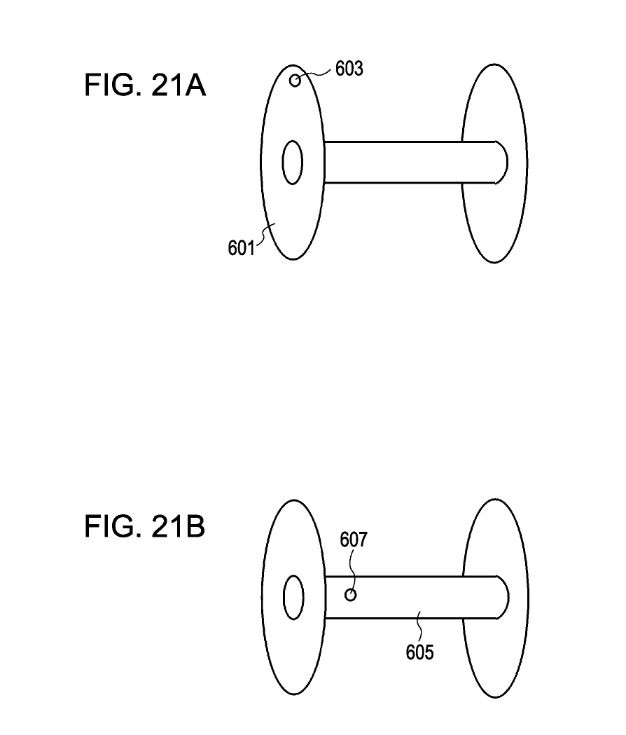

However, as shown in FIG. 21A, an IC tag 603 may be adhered to a flange 601. Further, as shown in FIG. 21B, an IC tag 607 may be adhered to a spool 605 around which a film is wound.

(b) In the above-described embodiment, the description is directed to the case where an IC tag is attached to a cartridge accommodating an image-forming material.

However, an IC tag may be attached to another member as far as it is a consumable. For example, an IC tag may be attached to a cartridge accommodating a printing medium (for example, a film or roll paper).

(c) In the above-described embodiment, the description is directed to the case where the version information for firmware and information relating to the acquisition sources for updated firmware are stored in an IC tag adhered to a consumable.

However, the storage medium that stores these pieces of information is not limited to an IC tag.

For example, the storage medium may be a semiconductor storage element, a magnetic storage element, a phase change storage element, a surface-shape-change storage element, or other such storage element. For example, the storage medium may be a one-dimensional or two-dimensional bar code. Alternatively, for example, the storage medium may be a hologram.

As described above, application to various kinds of storage media, either existing or developed in the future, is possible. This is because the amount of information stored in the storage medium is basically small.

That is, when a program for executing download of updated firmware is stored in a storage medium of a consumable, a medium that can secure at least a sufficient storage capacity for storing the program is used.

(d) In the above-described embodiment, the description is directed to the case where an IC tag is used as the storage medium of a consumable.

This storage medium may be either of a read-only type or a rewritable type. It should be noted, however, that the use of a rewritable type medium allows rewriting to the latest possible firmware version information to be done during the course of commercial distribution (factory shipments, warehouse, wholesale outlets, retail stores, and the like).

(e) In the above-described embodiment, the description is directed to the case where the version information for firmware and information relating to the acquisition sources for updated firmware are stored in a consumable, with basically one kind of electronic apparatus in mind.

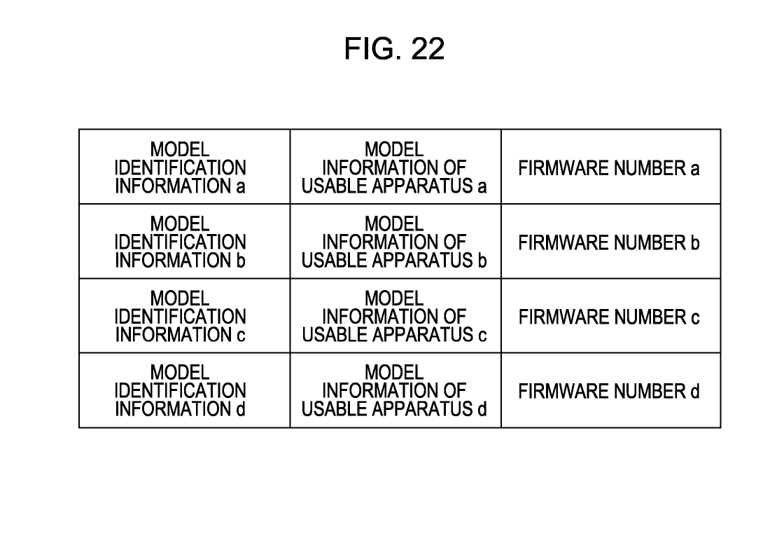

However, as shown in FIG. 22, a plurality of kinds of electronic apparatus and the corresponding firmware version information and the like may be stored in the storage medium of a consumable.

In this case, by simply loading a consumable into an electronic apparatus, reading of the firmware version information corresponding to the electronic apparatus into which the consumable has been loaded can be realized.

(f) In the above-described embodiment, the description is directed to the case where firmware version information read from an information medium adhered to a given consumable is checked against the version information of the own machine.

However, in the case where a plurality of consumables of the same kind are incorporated, of the pieces of version information read from information media attached to the respective consumables, the latest version information may be checked against the version information of the own machine.

Further, in the case where a plurality of consumables of different kinds are incorporated, of the pieces of version information read from information media attached to the respective consumables, the latest version information may be checked against the version information of the own machine.

(g) In the above-described embodiment, the description is directed to the case where the message or the like prompting a firmware update is displayed on the display section of the electronic apparatus (self-operation type printer) loaded with the consumable.

However, it is also possible to adopt a configuration in which the screen or the like prompting a firmware update is displayed on the display section of a peripheral apparatus that can communicate with the electronic apparatus loaded with the consumable. This proves particular effective when there is no display section in the electronic apparatus in which the consumable is loaded.

(h) In the above-described embodiment, the description is directed to the case where the firmware update management function is realized as software.

However, the equivalent function can be realized entirely or partially as hardware.

(i) Various modifications may be made to the above-described embodiment within the scope of the present invention. Further, various modifications and applications may be created or combined based on the description of this specification.

What is claimed is:

1. An electronic apparatus comprising:
a consumable-version-information holding section that holds version information of firmware read from an information medium of a consumable loaded in an own machine;
an own-machine-version information holding section that holds version information of firmware currently used in the own machine;
a version information comparing section that compares version information of the consumable and version information of the own machine with each other; and
an update message notifying section that displays a message that prompts updating of firmware on an information display section of the own machine or another machine when the version information of the consumable is newer than the version information of the own machine.

2. The electronic apparatus according to claim 1,
wherein the information medium is an IC tag.

3. The electronic apparatus according to claim 1,
wherein the information medium is a storage element.

4. The electronic apparatus according to claim 1,
wherein the information medium is a one-dimensional or two-dimensional bar code.

5. The electronic apparatus according to claim 1,
wherein the information medium is a hologram.

6. The electronic apparatus according to claim 1,
wherein the information medium stores version information of firmware corresponding to a plurality of apparatuses.

7. The electronic apparatus according to claim 1,
wherein the update message notifying section displays information relating to an acquisition source for updated firmware on the information display section of the own machine or another machine.

8. The electronic apparatus according to claim 7,
wherein the information relating to an acquisition source for updated firmware is read from a storage medium of the consumable.

9. The electronic apparatus according to claim 7,
wherein the information relating to an acquisition source for updated firmware is read from a storage medium bundled with the consumable.

10. The electronic apparatus according to claim 7,
wherein the information relating to an acquisition source for updated firmware is an existing location of updated firmware on a storage medium bundled with the consumable.

11. The electronic apparatus according to claim 7,
wherein the information relating to an acquisition source for updated firmware is an existing location of updated firmware on a computer network.

12. The electronic apparatus according to claim 7,
wherein the information relating to an acquisition source for updated firmware is an execution program for accessing an existing location of updated firmware on a computer network and downloading the updated firmware.

13. The electronic apparatus according to claim 7,
wherein the update message notifying section writes the information relating to an acquisition source for updated firmware into a storage medium loaded in an information recorder of the own machine or another machine.

14. A printer which is used with a consumable loaded therein, comprising:
a consumable-version-information holding section that holds version information of firmware read from an information medium of a consumable loaded in an own machine;
an own-machine-version information holding section that holds version information of firmware currently used in the own machine;
a version information comparing section that compares version information of the consumable and version information of the own machine with each other; and
an update message notifying section that displays a message that prompts updating of firmware on an information display section of the own machine or another machine when the version information of the consumable is newer than the version information of the own machine.

15. The printer according to claim 14,
wherein the printer is a self-operation type printing machine.

16. The printer according to claim 14,
wherein the printer is a fax machine.

17. The printer according to claim 14,
wherein the printer is a multifunction printing machine incorporating a scanner.

18. The printer according to claim 14,
wherein the printer is a label printing machine.

19. The printer according to claim 14,
wherein the consumable is a toner cartridge.

20. The printer according to claim 14,
wherein the consumable is an ink cartridge.

21. The printer according to claim 14,
wherein the consumable is an ink ribbon cartridge.

22. The printer according to claim 14,
wherein the consumable is a recording medium.

23. The printer according to claim 14,
wherein the consumable is a tape cartridge.

24. A program for causing a computer, which is incorporated in an electronic apparatus that is used with a consumable loaded therein, to execute the steps of:
reading version information of firmware corresponding to the consumable from an information medium of the consumable;
reading version information of firmware currently used in an own machine;
comparing version information of the consumable and version information of the own machine with each other; and
displaying a message that prompts updating of firmware on an information display section of the own machine or another machine when the version information of the consumable is newer than the version information of the own machine.

25. A consumable which is replaceably loaded in an electronic apparatus, comprising an information medium that stores information relating to an acquisition source for updated firmware.
